(19) United States
(12) Patent Application Publication
(10) Pub. No.: US 2011/0080265 A1
(43) Pub. Date: Apr. 7, 2011

(54) RFID TAG COMMUNICATION SYSTEM AND APPARATUS FOR COMMUNICATING WITH RFID TAG

(75) Inventors: Tsuyoshi ISOMURA, Ena-shi (JP); Katsumi TODA, Toyota-shi (JP); Yoshiyuki TSUJIMOTO, Nagoya-shi (JP)

(73) Assignee: BROTHER KOGYO KABUSHIKI KAISHA, Nagoya-shi Aichi (JP)

(21) Appl. No.: 12/960,845

(22) Filed: Dec. 6, 2010

Related U.S. Application Data
(63) Continuation-in-part of application No. PCT/JP2009/052910, filed on Feb. 19, 2009.

(30) Foreign Application Priority Data
Jun. 24, 2008 (JP) 2008-164463

(51) Int. Cl. H04Q 5/22

(52) U.S. Cl. 340/10.1

(57) ABSTRACT

The disclosure discloses an RFID tag communication system comprises: at least one RFID tag provided with one or more reversible identifiers capable of reverse at response; and a plurality of apparatuses, said apparatus including: an antenna device; a storage device configured to store a setting element of each of said one or more reversible identifiers; a setting portion configured to set the reversible identifier on the basis of said setting element; a reading command transmission portion configured to transmit a reading command by means of using said reversible identifier; a notification signal generation portion configured to generate an identifier notification indicating the reversible identifier; a notification signal output portion configured to output said identifier notification to the other apparatuses; a notification signal input portion configured to input said identifier notification from the other apparatuses; and a setting element update portion configured to update said setting element.

### CROSS-REFERENCE TO RELATED APPLICATION

This is a CIP application PCT/JP2009/52910, filed Feb. 19, 2009, which was not published under PCT article 21(2) in English.

### BACKGROUND OF THE INVENTION

1. Field of the Invention

The present invention relates to an RFID tag communication system that can transmit and receive information with an RFID tag and an apparatus for communicating with an RFID tag.

2. Description of the Related Art

A Radio Frequency Identification (RFID) system that performs information reading and writing of information of an RFID tag with a small-sized RFID tag by transmitting an inquiry in a non-contact manner from an apparatus for communicating with an RFID tag and by receiving a reply is known.

In the RFID system, there are cases in which a plurality of apparatuses for communicating with an RFID tag are installed so that their communicable ranges overlap each other to some degree.

In such prior art references, a controller that controls two reader/writers installed close to each other is disposed. The controller has first and second reader/writer control portions that control a first reader/writer and a second reader/writer, respectively, and a reader/writer switching portion. Usually, by means of the reader/writer switching portion, the first reader/writer is used through the first reader/writer control portion. The first reader/writer control portion detects if the first reader/writer is normally operating. If a failure is confirmed, the reader/writer switching portion makes switching through the second reader/writer control portion so that the second reader/writer is used. Thus, information reading can be continued reliably.

Applications of the RFID system include detection of all the RFID tags present in a relatively large predetermined space such as an office floor, a library, a warehouse by covering the entire space. In that case, a plurality of apparatuses for communicating with an RFID tag installed so that their communicable ranges overlap each other to some degree are used at the same time, and each of the apparatuses performs information reading.

In this case, radio waves from the plurality of apparatus for communicating with an RFID tag reach the RFID tags located in the overlapped communicable ranges. In order to perform correct information reading with each apparatus for communicating with an RFID tag in this state, smooth response communication from an RFID tag to each apparatus for communicating with an RFID tag is necessary while interference among the apparatuses for communicating with an RFID tag is prevented.

In the above prior art references, if one of the apparatuses for communicating with an RFID tags fails, information reading is continued by switching to another apparatus for communicating with an RFID tag. That is, correct information reading by each of the plurality of apparatuses for communicating with an RFID tag used at the same time as described above is not particularly considered.

### SUMMARY OF THE INVENTION

An object of the present invention is to provide an RFID tag communication system in which even if a plurality of apparatuses for communicating with an RFID tag perform reading at the same time, each apparatus for communicating with an RFID tag can perform information reading correctly and smoothly and an apparatus for communicating with an RFID tag.

### BRIEF DESCRIPTION OF THE DRAWING

FIG. 1 is a diagram illustrating an example of a case in which an RFID tag communication system of an embodiment of the present invention is applied to management of a large number of articles to which RFID tags are attached.

FIG. 2 is a system configuration diagram illustrating an outline of a handheld reader.

FIG. 3 is a functional block diagram illustrating a detailed configuration of a CPU, a radio frequency (RF) communication control part, and a reader antenna in each reader.

FIG. 4 is a block diagram illustrating an example of a functional configuration of an RFID tag circuit element disposed in the RFID tag.

FIG. 5 is a diagram illustrating an example of a time chart of a signal transmitted and received between the reader and the single RFID tag.

FIG. 6 is a table conceptually illustrating an example of a configuration of a session flag stored by the RFID tag circuit element of the RFID tag.

FIG. 7 is a table conceptually illustrating an example of a latest notification time table by session stored by each reader.

FIG. 8 is a flowchart illustrating a control procedure executed by the CPU of the handheld reader.

FIG. 9 is a flowchart illustrating a detailed procedure of tag information detection processing executed at Step S100 in FIG. 8.

FIG. 10 is a flowchart illustrating a control procedure executed by the CPU of the installed-type reader.

FIG. 11 is a flowchart illustrating a control procedure executed by a control part of the RFID tag circuit element.

FIG. 12 is a diagram illustrating an example of a sequence of a signal transmitted and received between the reader that executes the control procedure in FIGS. 8, 9, and 10 and the RFID tag that executes the control procedure in FIG. 11.

### DETAILED DESCRIPTION OF THE PREFERRED EMBODIMENTS

An embodiment of the present invention will be described below referring to the attached drawings. This embodiment is a case in which an RFID tag communication system of the present invention is applied to management of a large quantity of articles to which an RFID tag is attached, respectively, for example.

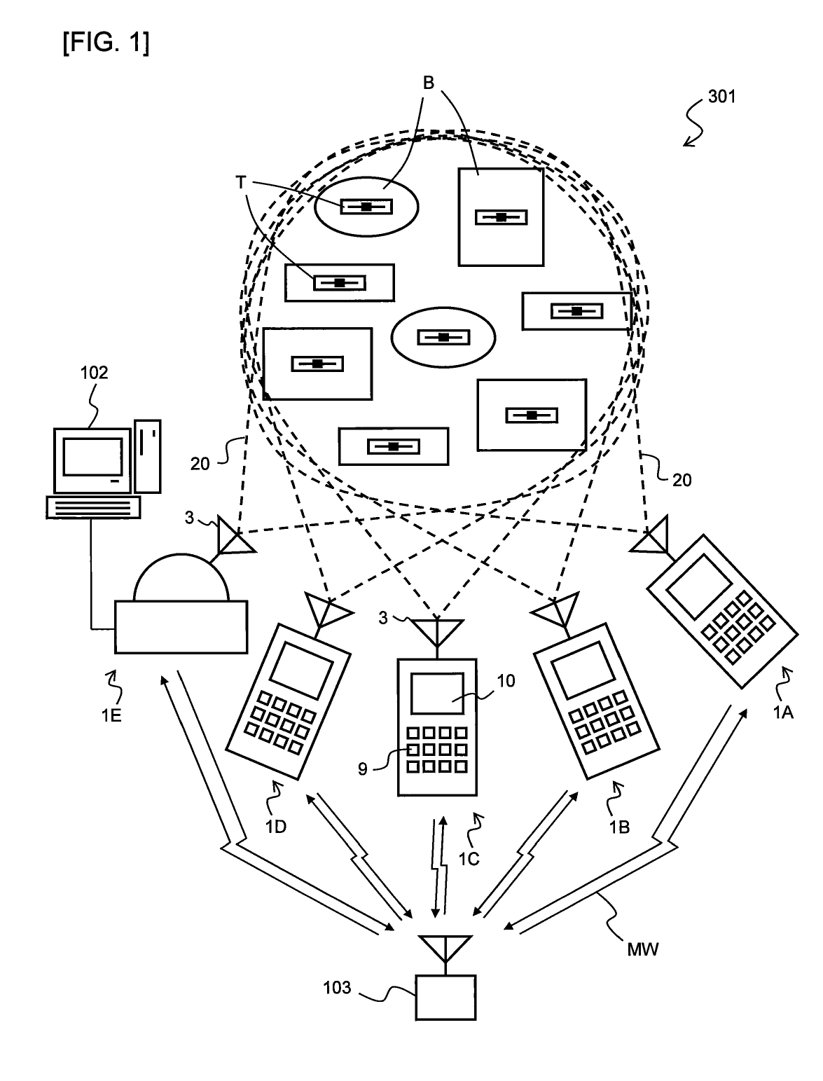

In FIG. 1, an RFID tag communication system 301 of this embodiment has an RFID tag T, a plurality of readers 1 and a radio access point 103. The RFID tag T is attached to each of a large number of managed articles B. Each reader 1 reads the respective tag IDs of the RFID tags T. The radio access point 103 is capable of transmission and reception of information and instruction signals through a wireless network MW such as a wireless LAN with all the readers 1A to 1E. In this example, four handheld readers 1A to 1D and one installed-type reader 1E are disposed.

Each of the readers 1A to 1E is provided with a reader antenna 3 as an antenna device. Also, in each of the handheld readers 1A to 1D, an operation part 9 and a display part 10 are further disposed. Also, the installed-type reader 1E is connected to a general-purpose computer (hereinafter referred to as a PC 102) through a peripheral equipment interface, for example, capable of information transmission and reception.

In this example, a plurality of operators, who are managers of the management articles B, use these readers 1A to 1E. The readers 1A to 1E read information relating to the corresponding management articles from the RFID tags T attached to each of the management articles B through radio communication. As a result, the managers manage storage states of each of the management articles B. Here, communicable areas 20, which are ranges shown by broken line in the figure, of the readers 1A to 1E are areas spread from each reader antenna 3 as an origin. This communicable area 20 is limited by its directivity and output power, which is so-called aerial power.

The RFID tags T are capable of radio communication with each of the readers 1A to 1E. By means of an operation by the operator, each of the readers 1A to 1E reads tag information including identification information from the RFID tag T (hereinafter referred to as a tag ID) in a state in which the target RFID tag T is located in the communicable area 20 spread from the reader antenna 3. The reader antenna 3 and its communicable area 20 of the installed-type reader 1E are not moved basically. Therefore, the communicable area 20 of the installed-type reader 1E is set in a range that contains the entire presence area of all the management articles B. On the other hand, the handheld readers 1A to 1D can be moved to an arbitrary position with the operator. Therefore, the communicable areas of the handheld readers 1A to 1D do not have to be of the size that contains the entire presence area of all the management articles B. In the figure, the communicable areas of the handheld readers 1A to 1D show an example in which the entire presence area of the management articles B are contained.

Also, when the operator performs a predetermined instruction operation at arbitrary timing to the operation part 9, the handheld readers 1A to 1D read tag information from the RFID tag T present in the communicable area 20 at that time. On the other hand, the installed-type reader 1E reads the tag information from all the RFID tags T since the PC 102 outputs a predetermined instruction signal.

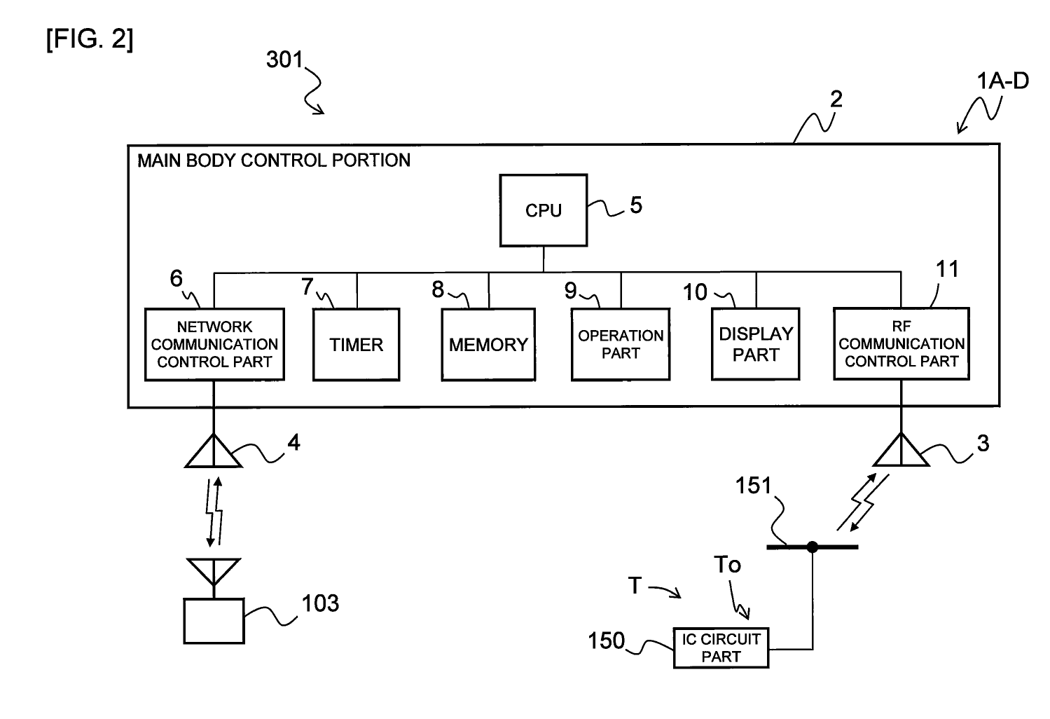

As shown in FIG. 2, the handheld readers 1A to 1D respectively include a main body control portion 2, a main antenna 4, and the reader antenna 3. The main antenna 4 conducts radio communication through the radio access points 103. The reader antenna 3 conducts radio communication with the RFID tag T.

The main body control portion 2 includes a CPU 5, which is a central processing unit, a network communication control part 6, a timer 7, a memory 8, the operation part 9, the display part 10, and a radio frequency (RF) communication control part 11. The network communication control part 6 performs transmission and reception of a signal with the radio access point 103 via the wireless network MW through the main antenna 4. The timer 7 measures time by the unit of 1 second. The memory 8 is composed of a RAM, a ROM, for example. The operation part 9 receives input of an instruction and information from the operator. The display part 10 displays various types of information and messages. The RF communication control part 11 controls radio communication with the RFID tag T through the reader antenna 3.

The CPU 5 performs signal processing in accordance with a program stored in advance in the ROM while using a temporary storage function of the RAM. As a result, the CPU 5 executes various controls of the entire handheld readers 1A to 1D.

The RFID tag T has an RFID tag circuit element To provided with a tag antenna 151 and an IC circuit part 150. The RFID tag T can be attached to the management article B by disposing the RFID tag circuit element To on a base material, not particularly shown, for example.

Though not particularly shown, the configuration of the installed-type reader 1E has an input and output interface that conducts signal transmission and reception with the PC 102 added to the system configuration of the handheld readers 1A to 1D, while the operation part 9 and the display part 10 are excluded. Since the other configurations are equal, detailed explanation will be omitted.

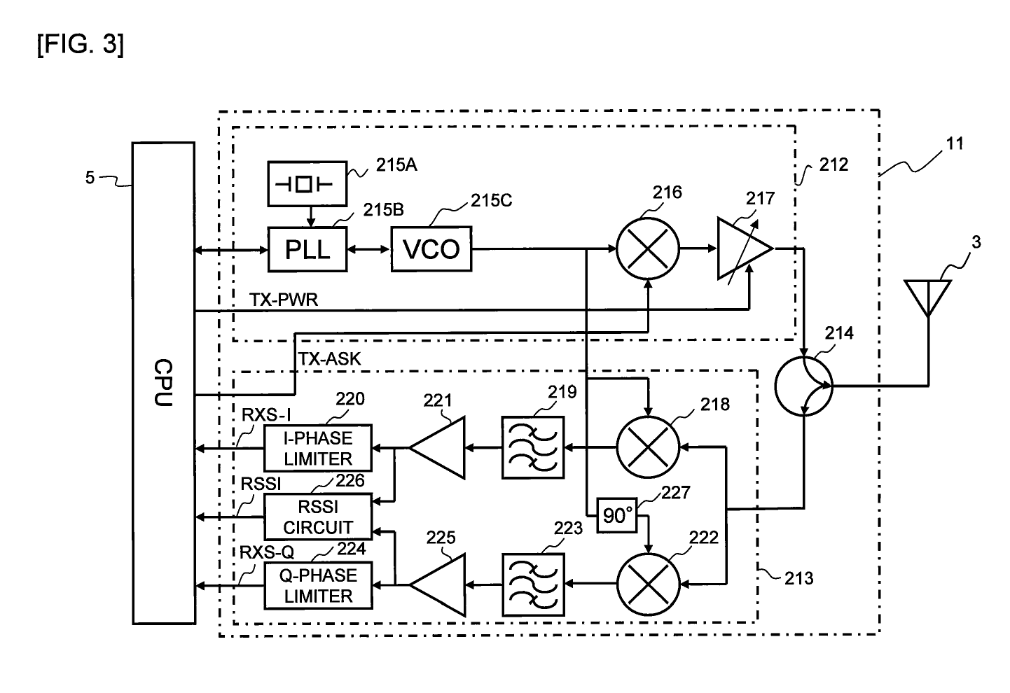

The detailed configurations of the CPU 5, the RF communication control part 11, and the reader antenna 3 in each reader 1 will be described using FIG. 3. The configuration shown in FIG. 3 is disposed in common in any of the handheld readers 1A to 1D and the installed-type reader 1E.

In FIG. 3, the CPU 5 processes a signal read from the IC circuit part 150 of the RFID tag circuit element To and reads information. Also, the CPU 5 generates a response request command in order to access the IC circuit part 150 of the RFID tag circuit element To.

The RF communication control part 11 accesses the information of the IC circuit part 150 of the RFID tag circuit element To through the reader antenna 3, that is, the RFID tag information including the tag ID. The RF communication control part 11 is composed of a transmitting portion 212, a receiving portion 213, and a transmit-receive splitter 214.

The transmitting portion 212 transmits a signal to the RFID tag circuit element To through the reader antenna 3. That is, the transmitting portion 212 is a block that generates an interrogation wave to access the RFID tag information of the IC circuit part 150 of the RFID tag circuit element To. In this example, the interrogation wave to perform only reading of the RFID tag information is generated. The transmitting portion 212 includes a crystal oscillator 215A that outputs a reference signal of a frequency, a Phase Locked Loop (PLL) 215B, a Voltage Controlled Oscillator (VCO) 215C, a transmission multiplying circuit 216, and a variable transmission amplifier 217. The PLL 215B and the VCO 215C generate a carrier wave with a predetermined frequency by dividing and multiplying an output of the crystal oscillator 215A by control of the CPU 5. The transmission multiplying circuit 216 modulates the carrier wave thus generated on the basis of a signal supplied from the CPU 5. In this example, the transmission multiplying circuit 216 performs amplitude modulation on the basis of a “TX_ASK” signal from the CPU 5. However, an amplification rate variable amplifier, for example, may be used instead of the transmission multiplying circuit 216. The variable transmission amplifier 217 amplifies a modulated wave modulated by the transmission multiplying circuit 216 and generates a desired interrogation wave. In this example, the variable transmission amplifier 217 performs amplification whose amplification rate is determined by a “TX_PWR” signal from the CPU 5.

As the carrier wave generated by the PLL 215B and the VCO 215C, a frequency of a UHF band, a micro wave band or a short wave band is used, for example. The output of the variable transmission amplifier 217 is transmitted to the reader antenna 3 through the transmit-receive splitter 214 and supplied to the IC circuit part 150 of the RFID tag circuit element To. The RFID tag information is not limited to the modulated signal as described above but can be a mere carrier wave.

The receiving portion 213 receives an input of a response wave from the RFID tag circuit element To received by the reader antenna 3. The receiving portion 213 includes an I-phase receiving signal multiplying circuit 218, an I-phase band-pass filter 219, an I-phase receiving signal amplifier 221, an I-phase limiter 220, a Q-phase receiving signal multiplying circuit 222, a Q-phase band-pass filter 223, a Q-phase receiving signal amplifier 225, and a Q-phase limiter 224. The I-phase receiving signal multiplying circuit 218 multiplies and demodulates a response wave from the RFID tag circuit element To received by the reader antenna 3 and the carrier wave thus generated. The I-phase band-pass filter 219 takes out only a signal in a required band from the output of the I-phase receiving signal multiplying circuit 218. The I-phase receiving signal amplifier 221 amplifies an output of the I-phase band-pass filter 219. The I-phase limiter 220 further amplifies the output of the I-phase receiving signal amplifier 221 and converts it to a digital signal. The Q-phase receiving signal multiplying circuit 222 multiplies the response wave from the RFID tag circuit element To received at the reader antenna 3 and the carrier wave whose phase is delayed by a phase shifter 227 by 90° after the generation. The Q-phase band-pass filter 223 takes out only a signal in a required band from the output of the Q-phase receiving signal multiplying circuit 222. The Q-phase receiving signal amplifier 225 amplifies an output of the Q-phase band-pass filter 223. The Q-phase limiter 224 further amplifies the output of the Q-phase receiving signal amplifier 225 and converts it to a digital signal. And a signal “RXS-I” outputted from the I-phase limiter 220 and a signal “RXS-Q” outputted from the Q-phase limiter 224 are inputted into the CPUS and processed.

Also, the outputs from the I-phase receiving signal amplifier 221 and the Q-phase receiving signal amplifier 225 are also inputted into a Received Signal Strength Indicator (RSSI) circuit 226 and a signal “RSSI” indicating the intensity of these signals is inputted into the CPU 5. With the arrangement, the readers 1A to 1E demodulate the response wave from the RFID tag circuit element To by I-Q quadrature demodulation.

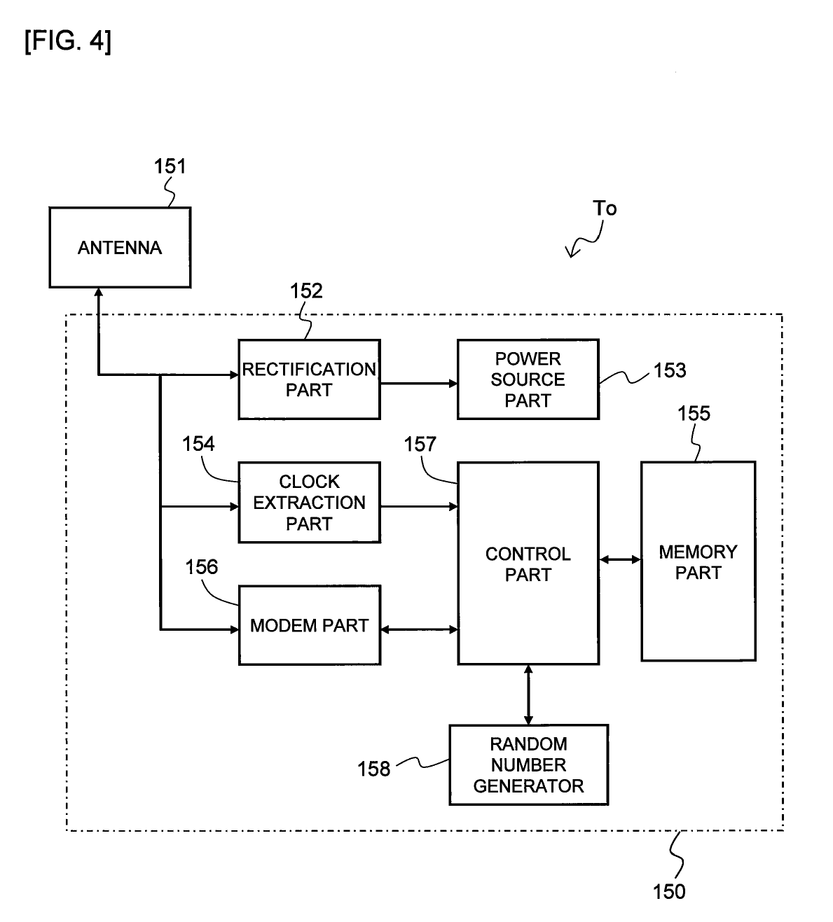

As shown in FIG. 4, the RFID tag circuit element To has the tag antenna 151 and the IC circuit part 150 connected to this tag antenna 151 as described above. The tag antenna 151 conducts transmission and reception of a signal in a non-contact manner with the reader antennas 3 of the readers 1A to 1E via radio communication or electromagnetic induction.

The IC circuit part 150 includes a rectification part 152, a power source part 153, a clock extraction part 154, a memory part 155, a modem part 156, a control part 157, and a random number generator 158. The rectification part 152 rectifies the interrogation wave, that is an interrogation signal, received by the tag antenna 151. The power source part 153 accumulates energy of the interrogation wave rectified by the rectification part 152 and uses the energy as a driving power source of the RFID tag circuit element To. The details of the interrogation signal will be described later.

The modem part 156 is connected to the tag antenna 151. The modem part 156 demodulates a communication signal from the reader antenna 3 of the apparatus 1 for communicating with an RFID tag, received by the tag antenna 151. The modem part 156 also modulates a reply signal from the control part 157 and transmits it as a response wave, that is, a signal including a tag ID, from the tag antenna 151.

The clock extraction part 154 extracts a clock component from the interrogation wave received by the tag antenna 151. The clock extraction part 154 supplies a clock corresponding to a frequency of the clock component of the received signal to the control part 157.

The random number generator 158 generates a random number that determines to which identification slot the RFID tag circuit element To outputs a response signal when the interrogation signal is received from the readers 1A to 1E. In this example, the random number generator 158 generates random numbers from 0 to 2^{Q}−1 to a slot number specified value Q specified in the interrogation signal from the readers 1A to 1E. The details of the random number generation and the identification slot will be described later.

The control part 157 executes basic control of the RFID tag circuit element To through the memory part 155, the clock extraction part 154, the random number generator 158, and the modem part 156, for example. Particularly, the control part 157 interprets a received signal demodulated by the modem part 156 and generates a reply signal on the basis of the information signal stored in the memory part 155. And the control part 157 replies the reply signal from the tag antenna 151 using the modem part 156 in the identification slot corresponding to the random number generated by the random number generator 158.

The memory part 155 stores a predetermined information signal. Particularly, in the memory part 155, four session flags S0, S1, S2, and S3 for distinguishing a communication session at that time are stored as reversible identifiers, capable of automatic reverse and change of the contents. The details of the session flags S0, S1, S2, and S3 will be described later. Instead of the storage of the session flags S0, S1, S2, and S3 in the memory part 155 as above, a register in the control part 157 may be used so as to have it perform the substantially equal function.

Here, the readers 1A to 1E of this embodiment transmits a command to specify and change contents of any one of the session flags S0, S1, S2, and S3 via radio communication to the RFID tag circuit element To. The RFID tag circuit element To has a specification complying with the international standards of ISO/IEC18000-6 Type C. Then, the readers 1A to 1E transmit a command that requests tag information only from the RFID tag circuit element To having the contents of any one of the session flags as the specified contents. The details will be sequentially described below.

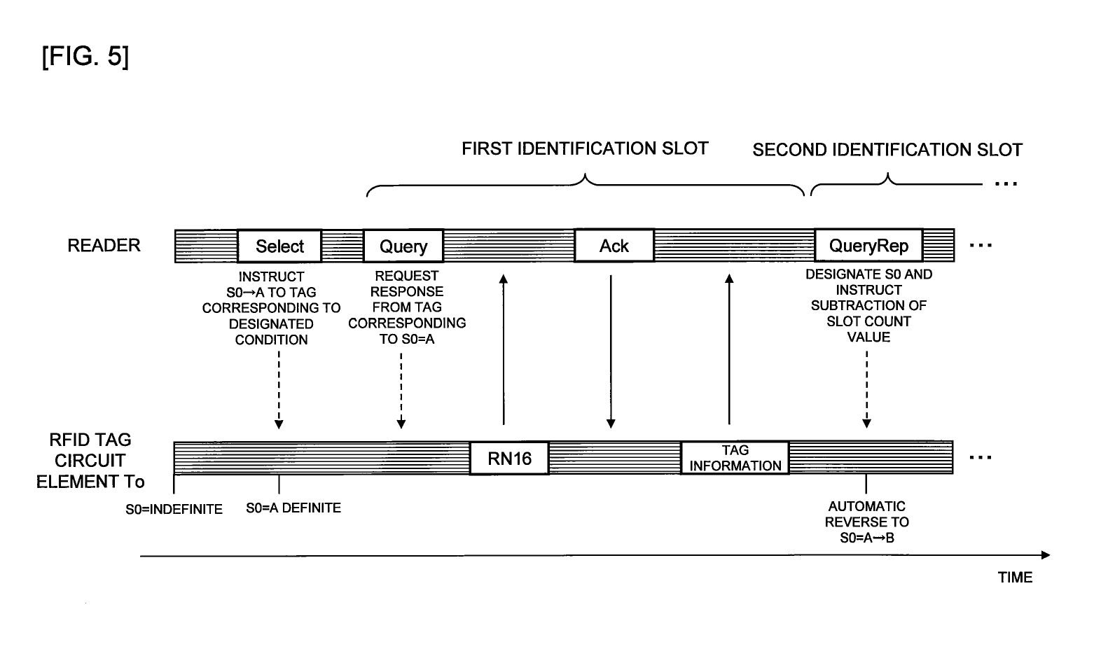

First, a signal transmitted and received between the readers 1A to 1E and the RFID tag circuit element To of the RFID tag T and its transmission and reception method will be described. As an example, a time chart of a signal transmitted and received between one reader 1 and the RFID tag circuit element To of one RFID tag T is shown in FIG. 5. The method of transmitting and receiving a signal shown in FIG. 5 complies with the ISO/IEC18000-6 Type C international standards based on the known Slotted Random method. In the figure, a change over time is shown from the left side to the right side. Also, arrows shown between the reader 1 and the RFID tag circuit element To indicate a transmission direction of the signal. The arrow in a broken line indicates a case in which the other party of transmission is unspecified, while the arrow in a solid line indicates a case in which the other party of transmission is specified.

In FIG. 5, the reader 1 first transmits a “Select” command as an identifier unifying command to the RFID tag circuit elements To of all the RFID tags T present in the communicable area 20. This “Select” command is a command to specify a condition of the RFID tag circuit element To with which the reader 1 conducts radio communication after that. By means of this command, various conditions are specified and the number of RFID tag circuit elements To whose information is to be read is limited so that efficiency of the radio communication can be improved. Only the RFID tag circuit element To satisfying the specified conditions in the RFID tag circuit elements To of the RFID tag T having received the “Select” command can conduct radio communication after that. In the figure, one of the RFID tag circuit elements To satisfying the specified conditions is shown.

Moreover, this “Select” command can arbitrarily specify and instruct to change the contents of the session flag S0 stored by the RFID tag circuit element To of the RFID tag T that satisfies the specified conditions. Here, S0 is used to represent the session flag, but the same applies to any of S0, S1, S2 or S3. The contents of the session flag S0 of the RFID tag circuit element To in this example has two types of state, that is, an “A” state and a “B” state. The communication state of the RFID tag circuit element To, that is, the so-called communication session can be distinguished from the contents of the session flag. In the illustrated example, the “Select” command instructs that the contents of the session flag S0 should be “A”. Thus, the contents of the session flag S0 of the RFID tag circuit element To, which have been indefinite, are defined as “A” upon reception of the “Select” command.

Subsequently, the reader 1 transmits a “Query” command as a reading command that requests an RFID tag group to respond and transmit the respective tag information. The tag information includes a tag ID, which is identification information. This “Query” command is a search command for making a search under a condition that the number of RFID tag circuit elements To expected to respond is indefinite. This “Query” command includes a slot number specified value Q specified with a predetermined number. For example, any of values from 0 to 15 is the slot number specified value Q in this example. If the RF communication control part 11 transmits the “Query” command through the reader antenna unit 3, each of the RFID tag circuit elements To of the RFID tags T creates random numbers from 0 to 2^{Q}−1, that is, Q power of 2−1, by the random-number generator 158. The RFID tag circuit element To holds the generated random number as a slot count value SC.

Moreover, this “Query” command can limit the RFID tag circuit element To from which a response is to be requested by the contents of the session flag S0. That is, the “Query” command includes the type and contents of the session flag to be arbitrarily specified together with the slot number specified value Q. The type of the session flag is S0 in this example. And only the one having contents of the stored session flag S0 at that time among the received RFID tag circuit elements To matching the specified contents included in the “Query” command, that is, the RFID tag circuit element in the same communication session, will transmit a response signal to the reader 1 after that. In the illustrated example, the “Query” command requests a response only from the RFID tag circuit element To with the contents of the session flag S0 as “A”. Then, as shown in the figure, the RFID tag circuit element To with the contents of the session flag S0 as “A” responds to the reader 1 after that.

After the reader 1 transmits the “Query” command through the reader antenna 3, the reader 1 waits for a response from the RFID tag circuit element To in a predetermined identification slot. The identification slot is a timeframe divided by a predetermined period after the “Query” command or a “QueryRep” command, which will be described later, is first transmitted. This identification slot is usually repeated continuously for a predetermined number of times. That is, in the identification slot, a single session of a first identification slot of the “Query” command and 2^{Q}−1 sessions of a second identification slot and after of the “QueryRep” command are repeated 2^{Q} times in total.

Then, as in the illustrated example, the RFID tag circuit element To having created a value 0 as the slot count value SC responds in the first identification slot containing this “Query” command. At this time, the RFID tag circuit element To transmits an “RN16” response using a pseudo random number of 16 bits, for example, in order to obtain permission to transmit the tag information to the reader 1 as a response signal.

Then, the reader 1 having received the “RN16” response transmits an “Ack” command to permit transmission of the tag information with the contents corresponding to the “RN16” response. If the “RN16” response transmitted previously by the RFID tag circuit element To itself and the received “Ack” command both include the same “RN16”, the RFID tag circuit element To having received this “Ack” command considers that the transmission of the tag information is permitted for itself. And the RFID tag circuit element To transmits the tag information including the tag ID. As described above, transmission and reception of a signal in a single identification slot is performed.

After that, further in the second identification slot and after, the reader 1 transmits the “QueryRep” command instead of the “Query” command. Then, the reader 1 waits for a response of another RFID tag circuit element To (not shown) in the identification slot timeframe disposed immediately after that similarly to the above. At this time, the RFID tag circuit element To of the RFID tag T with the specification complying with the ISO/IEC18000-6 Type C international standards automatically reverses and changes the contents of the session flag S0 to another contents different from before when it receives the “QueryRep” command. That is, the RFID tag circuit element To with the above-described specification reverses the contents of the session flag S0 from A to B, for example. Alternatively, the RFID tag circuit element To with the above-described specification reverses the contents of the session flag S0 from B to A. In the illustrated example, the RFID tag circuit element To having received the “QueryRep” command automatically reverses the contents of the session flag S0, which have been “A”, a state before the reverse, to the other “B”. As a result, even if the RFID tag circuit element To receives the “Query” command specifying the contents of the session flag S0 with “A” after that, the RFID tag circuit element To is in the standby state in which it does not perform a response operation.

This “QueryRep” command makes specification including only the type of the targeted session flag, that is, any of S0 to S3. Then, the RFID tag circuit element To having received the “QueryRep” command subtracts the value of its own slot count value SC only by 1 and holds it. Then, each RFID tag circuit element To transmits and receives a signal including the “RN16” response in the identification slot with the reader 1 at the time when the value of the slot count value SC becomes 0 similarly to the above.

If there is no applicable RFID tag circuit element To in each identification slot, that is, if there is no RFID tag circuit element To with the slot count value SC at 0 in the identification slot, the identification slot is finished with an elapse of a predetermined timeframe without transmission and reception of those other than the “Query” command or the “QueryRep” command. Also, a time interval between a plurality of transmitted and received commands is adjusted as appropriate so as to have an appropriate interval.

As described above, since each RFID tag circuit element To replies a response signal in different identification slot, the reader 1 can clearly receive and take in the tag information of the RFID tag circuit element To one by one through the reader antenna unit 3 without being subjected to interference. Also, even if the same RFID tag circuit element To receives the “Query” command specifying the contents of the same session flag S0 several times, once it responds to the “Query” command normally only for the first time, it no longer responds to the “Query” command received subsequently. As a result, wasteful repetition of transmission of the tag information by the RFID tag circuit element To of the same RFID tag T can be prevented.

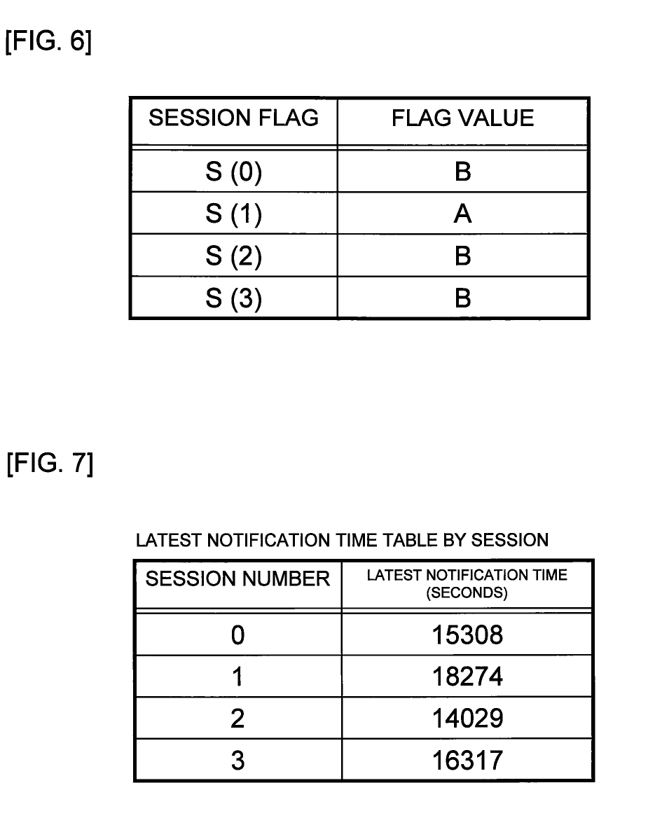

As described above, the RFID tag circuit element To of the RFID tag T with the specification complying with the ISO/IEC18000-6 Type C international standards individually has four session flags S0 to S3. As shown in FIG. 6, in this example, each of the session flags S0 to S3 has the contents of either “A” or “B”. In the following, for convenience of explanation, the four session flags are expressed as S(X) (X: session number=0, 1, 2, 3) as shown in the figure.

A latest notification time table by session shown in FIG. 7 shows information recorded and held in the memory 8 as a storage device disposed in each of the readers 1A to 1E.

In FIG. 7, the latest notification time table by session stores and records the session numbers that specify any one of the four session flags, that is, any of the numbers 0, 1, 2, and 3 and the latest notification time as time information corresponding to these session numbers. This latest notification time is the latest time when a notification signal notifying use of the session flag is received from any of the other readers 1A to 1E or the latest notification time of the transmission from itself to any of the other readers 1A to 1E. Here, the value of the timer 7 of each of the readers 1A to 1E that stores the latest notification time table by session is recorded as it is as the latest notification time. That is, as will be described, the time is cumulative time having been clocked all the time since the readers 1A to 1E are powered on, and it is expressed by the second in this example. The latest notification time constitutes a setting element described in each claim and also constitutes time information.

That is, when any one of the readers 1A to 1E is to perform one session of radio communication using the session flag, the reader transmits a session notification signal, which is an identifier notification, including the session number of the used session flag to the all the other readers 1 via the wireless network MW at the same time. The simultaneous transmission at this time is so-called transmission through broadcast communication but it also has an exception as will be described. Any of the other readers 1A to 1E having received this session notification signal records the clock contents at the time of the respective timer 7 in the latest notification time table by session. That is, any of the other readers 1A to 1E changes the contents of the latest notification time corresponding to the session number included in the received session notification signal to the time when the notification signal is received.

Here, if the readers 1A to 1E are powered on and started at different time, the clock contents of the respective timers 7 at the same time are different from each other. That is, the cumulative start times of the readers 1A to 1E are different from each other. As a result, absolute time of the latest notification time corresponding to the same session number in the latest notification time table by session stored in each of the readers 1A to 1E is different from each other. However, as described above, all the readers 1A to 1E change the latest notification time corresponding to each session number at the same time. As a result, a relative temporal relationship between the latest notification times according to the session number, that is, an order in a time series and the number of seconds between them are the same in the latest notification time tables by session of all the readers 1A to 1E.

In the RFID tag communication system 301 of this embodiment, each of the readers 1A to 1E selects and uses the session flag with the session number corresponding to the earliest latest notification time, that is, the session flag whose time to start use is the earliest in the radio communication using the session flag. In this embodiment, the value of the timer 7 that clocks the cumulative start times of the readers 1A to 1E by the second is recorded as it is as the time information, but not limited to that. That is, another time information that specifies relative temporal relationship may be recorded as the time information. For example, it may be so configured that all the timers 7 clock absolute natural time expressed by 00:00:00 to 23:59:59 in the same time zone and use the values. Alternatively, all the timers 7 may use general Universal Coordinated Time (UCT), that is, elapsed seconds from “00:00:00, January 1, 1970” as system time.

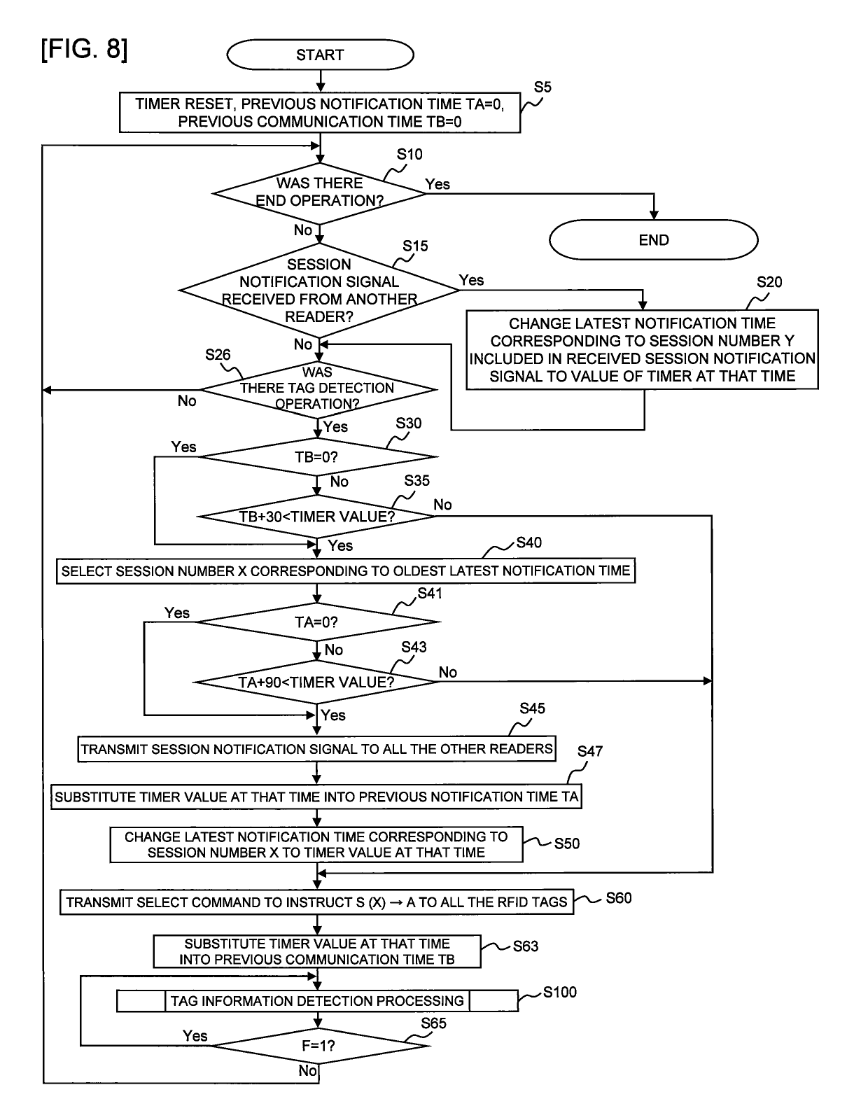

Using a flowchart shown in FIG. 8, a control procedure executed by the CPU 5 will be described. In FIG. 8, this flow is started after the power is turned on in this example. This state corresponds to a “START position” in the figure.

First, at Step S5, the CPU 5 resets the clock contents of the timer 7. Also, the CPU 5 resets and initializes the value of the previous notification time TA (See Step S47, which will be described later) and the value of the previous communication time TB (See Step S63, which will be described later). The previous notification time TA is a parameter that represents time when any of the handheld readers 1A to 1D transmitted the session notification signal the previous time. The previous communication time TB is a parameter that represents time when radio communication was conducted the previous time. Here, the CPU 5 substitutes 0 into the previous communication time TB. Subsequently, the timer 7 individually performs a clock operation by the second of the elapsed time.

After that, the routine goes to Step S10, and the CPU 5 determines whether the operator has performed an instruction operation to finish the operation state of the handheld readers 1A to 1D through the operation part 9 or not. If the finishing operation has been performed, the determination is satisfied, and this flow is finished as it is. On the other hand, if the finishing operation has not been performed, the determination is not satisfied, and the routine goes to Step S15.

At Step S15, the CPU 5 determines whether the session notification signal has been received or not from any of the other readers 1A to 1E through the wireless network MW. If the session notification signal has been received, the determination is satisfied, and the routine goes to Step S20. At Step S20, the CPU 5 changes the latest notification time table by session by recording the value of the timer 7 at that time at the latest notification time corresponding to the session number Y included in the received session notification signal of the latest notification time table by session (See FIG. 7). The routine goes to Step S26. On the other hand, if the session notification signal has not been received at Step S15, the determination is not satisfied, and the routine goes to Step S26 as it is.

At Step S26, the CPU 5 determines whether the operator has performed an instruction operation to read the tag information of the RFID tag T through the operation part 9, that is, whether the operator has inputted an instruction signal or not. If the operator has not performed the reading operation, the determination is not satisfied, the routine returns to Step S10 as it is, and the similar procedure is repeated. On the other hand, if the reading operation has been performed, the determination is satisfied, and the routine goes to Step S30.

At Step S30, the CPU 5 determines whether the value of the previous communication time TB is 0 or not, that is, whether it is the first tag information reading since the handheld readers 1A to 1D are started or not. If the value of the previous communication time TB is 0, the determination is satisfied, and the routine goes to Step S40. On the other hand, if the value of the previous communication time TB is not 0, the determination is not satisfied. That is, the CPU 5 considers that radio communication to read the tag information has been conducted at least once from the start of the handheld readers 1A to 1D to that point of time (See Step S63). Then, the routine goes to Step S35.

At Step S35, the CPU 5 determines whether the value of the timer 7 at that time is larger than the value obtained by adding a predetermined value to the previous communication time TB or not. The CPU 5 uses 30 as the predetermined value in this example. That is, the CPU 5 determines whether the reading of the tag information which the handheld readers 1A to 1D performed the previous time was performed within 30 seconds, which is a second threshold value, or not. If the value of the timer 7 is not more than the value obtained by adding 30 to the previous communication time TB, the determination is not satisfied. That is, the CPU 5 considers that 30 seconds have not elapsed yet since the handheld readers 1A to 1D performed previous reading of the tag information. Then, the routine goes to Step S60, which will be described later. On the other hand, if the value of the timer 7 is larger than the value obtained by adding 30 to the previous communication time TB, the determination at Step S35 is satisfied. That is, the CPU 5 considers that 30 seconds have already elapsed since the handheld readers 1A to 1D performed previous reading of the tag information. Then, the routine goes to Step S40.

As described above, if the tag information has not been read yet even once since the handheld readers 1A to 1D were started or if 30 seconds have already elapsed since the handheld readers 1A to 1D read the tag information the previous time, the routine goes to Step S40. At Step S40, the CPU 5 detects the earliest latest notification time in the latest notification time table by session (See FIG. 7). Then, the CPU 5 selects the session number X corresponding to the detected latest notification time as the specified number of the session flag to be used in radio communication for tag information reading performed immediately after that. Subsequently, the routine goes to Step S41.

At Step S41, the CPU 5 determines whether the value of the previous notification time TA is 0 or not. That is, the CPU 5 determines if the session notification signal has not been transmitted yet to another reader 1 even once since the handheld readers 1A to 1D were started or not. If the value of the previous notification time TA is 0, the determination is satisfied, and the routine goes to Step S45. On the other hand, if the value of the previous notification time TA is not 0, the determination is not satisfied. That is, the CPU 5 considers that the session notification signal has been transmitted at least once from the start of the handheld readers 1A to 1D to that point of time (See Step S47). Then, the routine goes to Step S43.

At Step S43, the CPU 5 determines whether the value of the timer 7 at that time is larger than the value obtained by adding a predetermined value to the previous notification time TA or not. The CPU 5 uses 90 as the predetermined value in this example. That is, the CPU 5 determines whether the transmission of the session notification signal performed by the handheld readers 1A to 1D the previous time was performed within 90 seconds, which is a first threshold value, or not. If the value of the timer 7 is not more than the value obtained by adding 90 to the previous notification time TA, the determination is not satisfied. That is, the CPU 5 considers that 90 seconds have not elapsed yet since the handheld readers 1A to 1D performed the previous transmission of the session notification signal. Then, the routine goes to Step S60, which will be described later. On the other hand, if the value of the timer 7 is larger than the value obtained by adding 90 to the previous notification time TA, the determination is satisfied. That is, the CPU 5 considers that 90 seconds have already elapsed since the handheld readers 1A to 1D performed previous transmission of the session notification signal. Then, the routine goes to Step S45.

At Step S45, the CPU 5 transmits the session notification signal including the session number X selected at Step S40 to all the other readers 1 by broadcast communication through the wireless network MW. At this time, even if the wireless network MW includes a wireless LAN using known TCP/IP, for example, the session notification signal can be transmitted easily and rapidly through the broadcast communication. That is because the broadcast communication can be made using a signal transmission path if the signal transmission path to another reader 1, that is, a communication path is already established even once. After that, the routine goes to Step S47, and the CPU 5 substitutes the value of the timer 7 at this time into the previous notification time TA.

Then, the routine goes to Step S50, and the CPU 5 changes the latest notification time table by session by recording the value of the timer 7 at that time with respect to the latest notification time corresponding to the session number X selected at Step S40 in the latest notification time table by session. Then, the routine goes to Step S60, which will be described later.

As described above, if 30 seconds have already elapsed since the handheld readers 1A to 1D performed the previous reading of the tag information or if the reading of the tag information has not been performed yet even once since the start, the session number newly used by the handheld readers 1A to 1D is selected and set at Step S40. Moreover, if 90 seconds have already elapsed since the previous session notification signal was transmitted or if the session notification signal has not been transmitted yet even once since the start, at Step S45, Step S47, and Step S50, the latest notification time tables by session of all the readers 1A to 1E are updated using the session number set at Step S40.

On the other hand, if 30 seconds have not elapsed since the handheld readers 1A to 1D performed the previous reading of the tag information, the CPU 5 sets the previous session number X as the session number. That is, setting is not made. Then, Step S40, Step S45, Step S47, and Step S50 are omitted, and the routine goes to Step S60. Even if 30 seconds have elapsed since the handheld readers 1A to 1D performed the previous reading of the tag information, if 90 seconds have not elapsed yet from the previous transmission of the session notification signal, the CPU 5 omits Step S45, Step S47, and Step S50. That is, though the session number X is newly set, the session notification signal is not transmitted, and the routine goes to Step S60.

At Step S60, in this example, the CPU 5 transmits the “Select” command that instructs the RFID tag T to set the contents of the respective session flags S(X) to “A” without specifying any condition for the radio communication. This command is transmitted to all the RFID tags T present within the communicable areas 20 of the handheld readers 1A to 1D at that time. This “Select” command includes the fact that a condition for the radio communication is not specified, the session number X of the session flag to be used, and the set contents “A” of the session flag. As a result, the contents of the session flags S(X) of all the RFID tags T present within the communicable areas 20 of the handheld readers 1A to 1D are fixed to “A”. It may be so configured that a predetermined condition for the radio communication is specified by this “Select” command and the number of the RFID tag circuit elements To as information reading targets is limited so as to improve efficiency of the radio communication. After that, the routine goes to Step S63, and the CPU 5 substitutes the value of the timer 7 at this time in the previous communication time TB.

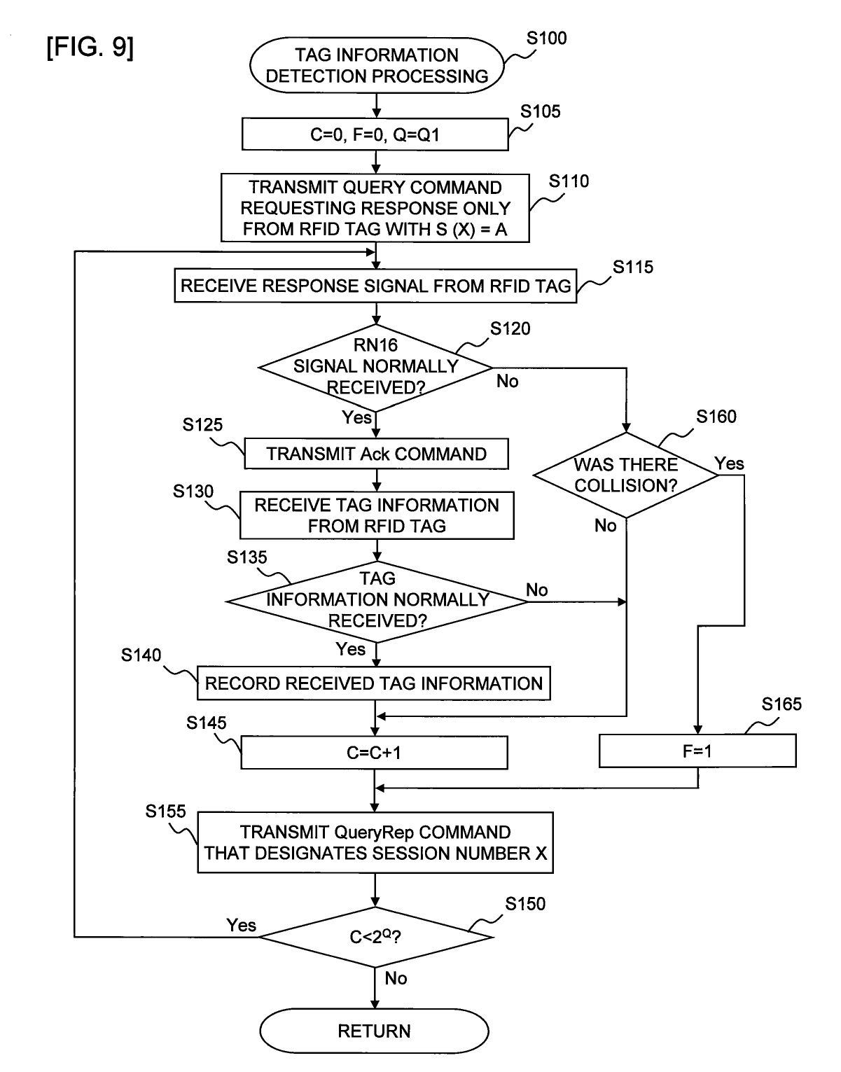

After that, the routine goes to Step S100, and the CPU 5 executes tag information detection processing to detect the respective tag information of all the RFID tags T present within the communicable areas 20 of the handheld readers 1A to 1D at this time (See FIG. 9, which will be described later). In this tag information detection processing, in the case of a collision of response signals of the RFID tags T in the middle of the processing, the value of a collision occurrence flag F becomes “1”, and the processing is interrupted. This interruption of the processing is expressed by the flow from Step S160 to Step S165 in FIG. 9, which will be described later.

Then, the routine goes to Step S65, and the CPU 5 determines whether the contents of the collision occurrence flag F have become “1” or not. That is, the CPU 5 determines whether a collision of the response signals of the RFID tags T has occurred or not in the tag information detection processing at Step S100 executed immediately before. If the contents of the collision occurrence flag are “1”, the determination is satisfied. That is, the CPU 5 considers that since detection of the tag information has failed, the tag information detection processing needs to be executed again. Then, the routine returns to Step S100. On the other hand, if the contents of the collision occurrence flag are not “1”, the determination is not satisfied. That is, the CPU 5 considers that the detection of the tag information was successful and executes predetermined notification processing. That is, the CPU 5 performs notification of the successful detection of the tag information and notification relating to the read tag information (not particularly shown). After that, the routine returns to Step S10 and repeats the similar procedure.

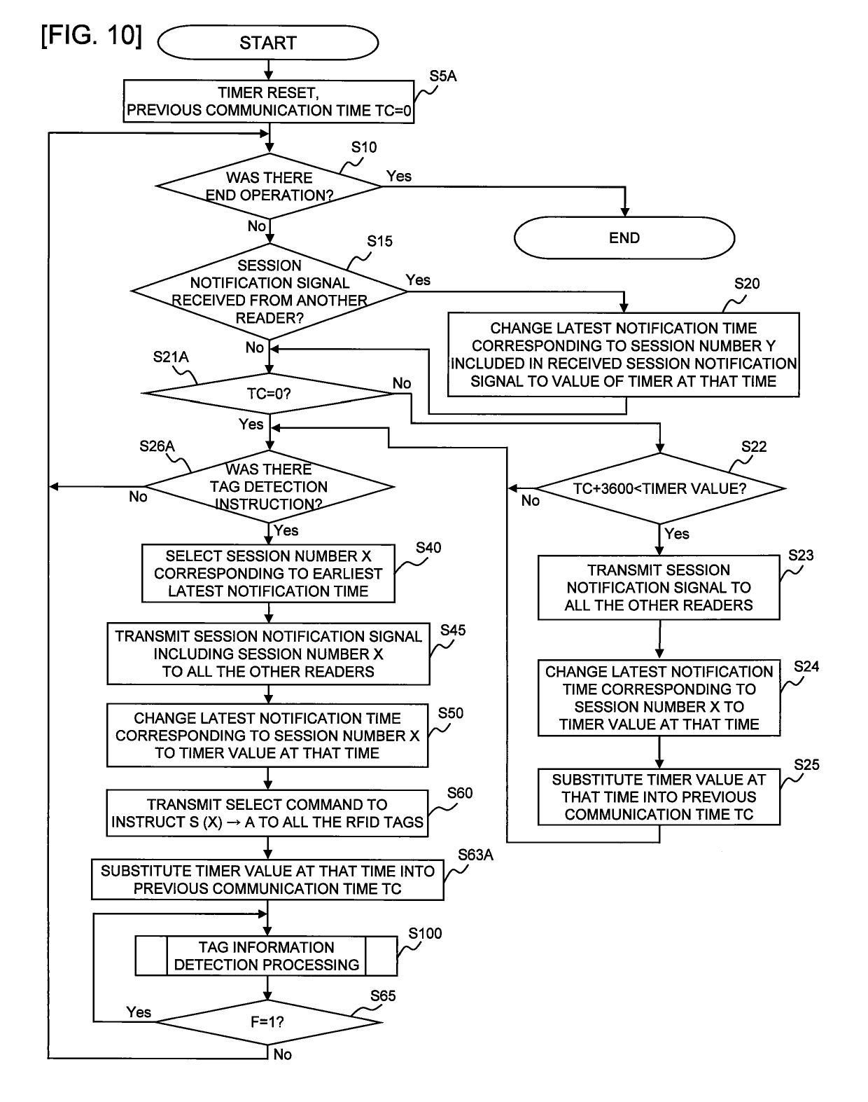

The tag information detection processing executed by the readers 1A to 1D at Step S100 in FIG. 8 will be described using FIG. 9. In FIG. 9, the procedure of this flow is executed in a state in which the session number X is set in advance (See Step S40) as described above. This tag information detection processing is also executed by the reader 1A at Step S100 in FIG. 10, which will be described later.

First, at Step S105, the CPU 5 executes initialization processing. That is, the CPU 5 sets a counter variable C to 0, the collision occurrence flag F to 0, and the value of the slot number specified value Q to Q1. This set value Q1 is a parameter that sets the number of identification slots to perform detection of the tag information in the tag information detection processing at this Step S100. And the set value Q1 is inputted and set by the operator in advance in accordance with the size of the communicable areas 20 of the readers 1A to 1D and the number of the RFID tags T expected to be capable of the radio communication among them.

After that, the routine goes to Step S110, and the CPU 5 transmits the “Query” command through the reader antenna 3 and the RF communication control part 11. This “Query” command includes the slot number specified value Q already set as described above. Also, the “Query” command includes the session number X of the session flag S(X) to limit the RFID tag T from which a response is requested and the contents of the target session. The session number X is any of 0 to 3, and the contents of the session is A or B. In this example, the contents of the session flag S(X) is limited by “A”.

After that, the routine goes to Step S115, and the CPU 5 receives a response signal from the RFID tag T only for a predetermined period of time through the reader antenna 3 and the RF communication control part 11. After that, at Step S120, the CPU 5 determines whether the “RN16” response has been normally received or not as a response signal during the reception time. That is, the CPU 5 determines whether only the single “RN16” response has been normally received, not that there was no response or no occurrence of a collision among the plurality of “RN16” responses. In this determination, if the “RN16” response has been normally received, the determination is satisfied. That is, the CPU 5 considers that there is the RFID tag T that makes a response in the identification slot. Then, the routine goes to Step S125.

At Step S125, the CPU 5 transmits the “Ack” command with the contents corresponding to the pseudo random number included in the “RN16” response received at Step S115 through the RF communication control part 11 and the reader antenna 3. After that at Step S130, the CPU 5 receives the tag information including the tag ID, which is the identification information, from the RFID tag T for a predetermined period of time through the reader antenna 3 and the RF communication control part 11. After that, the routine goes to Step S135.

At Step S135, the CPU 5 determines whether the tag information has been normally received during the reception time or not. That is, the CPU 5 determines whether the single piece of tag information has been normally received or not instead of no response. In this determination, if the tag information has been normally received, the determination is satisfied. That is, the CPU 5 considers that the tag information has been detected from the single RFID tag T in the identification slot, and the routine goes to Step S140. At Step S140, the CPU 5 stores the detected tag information in a predetermined storage area in the memory 8. After that, the routine goes to Step S145. On the other hand, if the tag information has not been normally received due to a cause such as radio interference, for example, at Step S135, the determination at Step S135 is not satisfied. That is, the CPU 5 considers that the radio communication has failed, and the routine goes to Step S145.

At Step S145, the CPU 5 adds 1 to the value of the counter variable C, and the routine goes to Step S155. At Step S155, the CPU 5 transmits the “QueryRep” command through the RF communication control part 11 and the reader antenna 3. This “QueryRep” command also includes specification of the session flag S0 to limit the RFID tag T from which a response is requested. After that, the routine goes to Step S150.

At Step S150, the CPU 5 determines whether the value of the counter variable C is smaller than 2^{Q} or not. If the value of the counter variable C is smaller than 2^{Q}, the determination is satisfied. That is, the CPU 5 considers that the current tag information detection processing has not been fmished yet, and the routine returns to Step S115 and repeats the similar procedure.

On the other hand, in the determination at Step S150, if the value of the counter variable C is 2^{Q} or more, the determination is not satisfied, and this flow is fmished.

Also, on the other hand, in the determination at Step S120, if the “RN16” response has not been normally received, the determination is not satisfied. That is, the CPU 5 considers that the RFID tag T responding in the identification slot is not present and no response was made or a collision of the “RN16” responses from a plurality of the RFID tags T occurred, and the routine goes to Step S160.

At Step S160, the CPU 5 determines whether a collision by a plurality of “RN16” responses has occurred or not during the reception time at Step S115. That is, the CPU 5 determines whether the reason why it is determined that the “RN16” response has not been received normally in the determination at Step S120 is a collision or not. If a collision by the “RN16” responses has occurred, the determination is satisfied. That is, the CPU 5 considers that detection in the current tag information detection processing has failed, and the routine goes to Step S165. At Step S165, the CPU 5 sets the value of the collision occurrence flag F to “1”. This value of “1” indicates occurrence of a collision (See Step S65 in FIG. 8). After that, the routine goes to Step S155.

Also, on the other hand, in the determination at Step S160, if a collision by the “RN16” responses has not occurred, the determination is not satisfied. That is, the CPU 5 considers that the RFID tag T responding in the identification slot is not present and no response was made, and the routine goes to the above-described Step S145.

A control procedure executed by the CPU 5 of the installed-type reader 1E will be described using FIG. 10. This FIG. 10 corresponds to FIG. 8 in the handheld readers 1A to 1D. In FIG. 10, this flow is started after the power is turned on in this example. This state corresponds to a “START position” in the figure.

The flow in FIG. 10 has the substantially same flow but is different in the following points. That is, instead of Step S5, Step S21, Step S26, and Step S63 in FIG. 8, Step S5A, Step S21A, Step S26A, and Step S63A are provided, respectively. Also, between Step S15 and Step S26 in the flow in FIG. 8, a procedure from Step S21 to Step S25 to transmit a session notification signal by broadcast communication in a predetermined cycle is added. Also, Step S30, Step S35, Step S41, and Step S43 in the flow in FIG. 8 are omitted.

That is, at Step S5A in FIG. 10, the CPU 5 initializes the previous communication time TC corresponding to the previous communication time TB in FIG. 8 instead of initialization of the previous notification time TA and the previous communication time TB to 0 at Step S5 in FIG. 8. After that, Step S10, Step S15, and Step S20 are the same as in FIG. 8.

At Step S21A provided instead of Step S21 in FIG. 8, the CPU 5 determines if the value of the previous communication time TC is 0 or not. That is, the CPU 5 determines whether the reading of the tag information has been performed even once or not since the installed-type reader 1E was started. If the value of the previous communication time TC is 0, the determination is satisfied, and the routine goes to step S26A. If the value of the previous communication time TC is not 0 (See Step S65A, which will be described later), the determination is not satisfied. That is, the CPU 5 considers that radio communication for reading the tag information has been conducted at least once till that time since the installed-type reader 1E was started. And the routine goes to Step S22.

Step S22, Step S23, Step S24, and Step S25 correspond to Step S35, Step S45, Step S50, and Step S55 in the flow in FIG. 8, respectively, in the order and have substantially equivalent processing contents. At Step S22, a predetermined value to be compared with the value of the timer 7 at that time is a value obtained by adding 3600 to the previous communication time TC in this example. That is, the CPU 5 determines whether the reading of the tag information performed previous time by the installed-type reader 1E has been performed within 60 minutes, which is a third threshold value. If the value of the timer 7 is larger than the value obtained by adding 3600 to the previous communication time T, the determination is satisfied. That is, the CPU 5 considers that 60 minutes have already elapsed since the installed-type reader 1E performed the reading of the tag information previous time, and Step S23, Step S24, and Step S25 are executed and then, the routine goes to Step S26A. On the other hand, if the value of the timer 7 is not more than the value obtained by adding 3600 to the previous communication time T, the determination is not satisfied, and the routine goes to Step S26A.

According to Step S21A, Step S22, Step S23, Step S24, and Step S25, the following advantages are obtained. That is, if 60 minutes have elapsed without input of an instruction signal to instruct reading of the tag information from the PC since the installed-type reader 1E performed the tag information reading once or more, the session notification signal including the session number X used by the installed-type reader 1E is transmitted to the other handheld readers 1A to 1D by broadcast communication. As a result, the corresponding latest notification time in the latest notification time table by session of the readers 1A to 1D can be changed. Also, the value of the previous communication time TC is changed at the same timing.

At Step S26 in FIG. 8, the CPU 5 determines whether an instruction operation to perform the tag information reading has been inputted from the operator through the operation part 9 of any of the handheld readers 1A to 1D or not. On the other hand, at Step S26A provided instead of Step S26, the CPU 5 determines whether an instruction signal to perform the tag information reading has been inputted from the PC 102 to the installed-type reader 1E or not.

After that, Step S40, Step S45, Step S50, and Step S60 are the same as in FIG. 8. Also, at Step S63A provided instead of Step S63, the CPU 5 substitutes the value of the timer 7 at this time in the previous communication time TC. Subsequently, Step S100 and Step S65 are the same as in FIG. 8, and the explanation will be omitted.

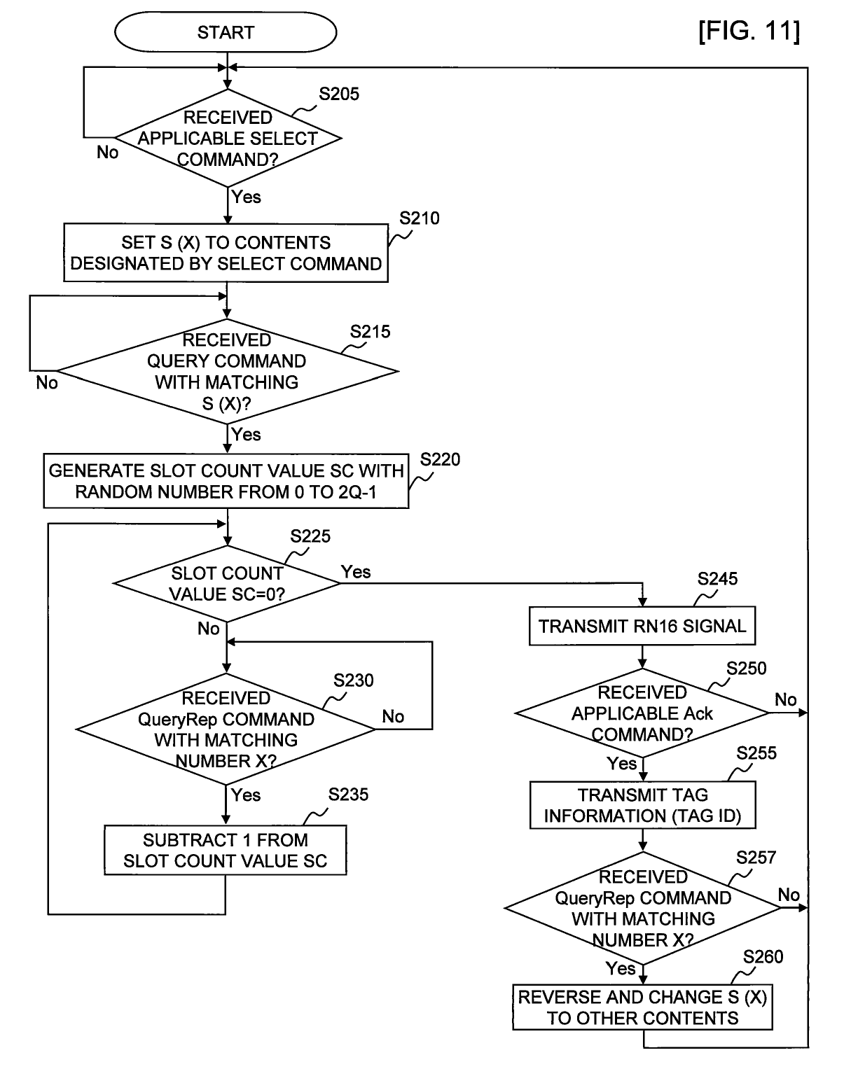

The control procedure executed by the control part 157 of the RFID tag circuit element To will be described using a flowchart in FIG. 11. In FIG. 11, for example, if the RFID tag circuit element To receives an initialization command whose detailed explanation is omitted, radio power is given by the initialization signal, and the control part 157 is initialized, the RFID tag circuit element To is started up. And this flow is started. This state corresponds to the “START” position in the figure.

First, at Step S205, the control part 157 interprets instruction contents of the “Select” command from the reader antenna 3 of each of the readers 1A to 1E, received by the tag antenna 151 immediately after the RFID tag circuit element To was started up. Then, the control part 157 determines whether the specified condition included in the instruction contents, that is, the condition of the RFID tag T to be read by each of the readers 1A to 1E is applicable to the RFID tag T or not. If the RFID tag T does not fall under the specified condition, the determination at Step S205 is not satisfied. That is, the control part 157 repeats the same procedure and stands by in a loop until the “Select” command including the specified condition applicable to the RFID tag T is received. On the other hand, if the “Select” command including the specified condition applicable to the RFID tag T is received, the determination at Step S205 is satisfied, and the routine goes to Step S210.

At Step S210, the control part 157 sets the contents of its own session flag S(X) to the contents specified by the “Select” command received at Step S205. In this example, in any of the “Select” commands transmitted from the readers 1A to 1E at Step S60 in the flow of FIGS. 8 and 10, the condition for the radio communication is not specified, and the session number X of the session flag to be used and the set contents “A” of the session flag are included. As a result, each time the “Select” command is received, the contents of the session flag S(X) is fixed to “A”.

After that, the routine goes to Step S215, and the control part 157 interprets the instruction contents of the “Query” command from the reader antenna 3 of each of the readers 1A to 1E received by the tag antenna 151 subsequently to the “Select” command. Then, the control part 157 determines whether or not the contents of the session flag S(X) stored by the RFID tag T match the limitation condition of the RFID tag T from which each of the readers 1A to 1E requests a response, which is the contents of the specified session flag S(X) included in the instruction contents.

If the contents of the session flag S(X) stored by the RFID tag T do not match the contents of the session flag S(X) specified by the “Query” command, the determination at Step S215 is not satisfied. That is, the control part 157 repeats the same procedure and stands by in a loop until the “Query” command including the matching specified session flag S(X), that is, the “Query” command in which both the session number X and the contents of the session flag S(X) match is received. On the other hand, if the “Query” command including the specified session flag S(X) matching the session flag S(X) stored by the RFID tag T is received, the determination at Step S215 is satisfied, and the routine goes to Step S220. Also, at this time, the control part 157 makes the slot number specified value Q included in the “Query” command stored in the memory part 155.

At Step S220, on the basis of the slot number specified value Q stored in the memory part 155 at Step S215, the control part 157 generates the random numbers from 0 to 2^{Q}−1 by the random number generator 158. The control part 157 sets the generated value to the slot count value SC. By means of this slot count value SC, the identification slot in which the RFID tag T transmits the response signal, that is, “RN16” response in this example is determined.

After that, the routine goes to Step S225, and the control part 157 determines whether the slot count value SC is 0 or not. If the slot count value SC is not 0, the determination is not satisfied. That is, the control part 157 considers that the identification slot to transmit the response signal has not been reached. After that, the routine goes to Step S230.

At Step S230, the control part 157 determines whether the “QueryRep” command transmitted from the readers 1A to 1E at Step S155 in the flow of FIG. 9 has been received through the tag antenna 151 or not. As described above, the “QueryRep” command also includes the session number X. Therefore, the control part 157 determines whether the session number X included in the “QueryRep” command, if received, matches the session number X included in the “Query” command received at Step S215 or not at the same time. In other words, the control part 157 determines whether or not it is the “Query” command in the same communication session as the “Query” command received immediately before that.

If the “QueryRep” command has not been received or if the session number X included in the received command does not match the session number X included in the “Query” command immediately before that, the determination at Step S230 is not satisfied, and the routine stands by in a loop. If the “QueryRep” command has been received and the session number X of the specified session flag S(X) included therein matches the session number X stored by the RFID tag T, the determination at Step S230 is satisfied. As a result, the routine goes to Step S235, the control part 157 subtracts 1 from the slot count value SC, and the routine returns to Step S225 and repeats the similar procedure.

Also, on the other hand, if the slot count value SC is 0 in the determination at Step S225, the determination is satisfied. That is, the control part 157 considers that the identification slot in which the RFID tag T should transmit the response signal has been reached, and the routine goes to Step S245. At Step S245, the control part 157 makes the modem part 156 generate the “RN16” response using a 16-bit pseudo random number, for example, as a response signal and replies it to the readers 1A to 1E through the tag antenna 151 at a predetermined timing.

After that, the routine goes to Step S250, and the control part 157 determines whether the “Ack” command with the contents including the “RN16” response transmitted at Step S245 as it is has been received through the tag antenna 151 or not. If the “Ack” command has been received through the tag antenna 151, and the contents are those including the “RN16” response transmitted by the RFID tag T itself previously as it is, the determination is satisfied. That is, the control part 157 considers that the RFID tag T is allowed from the readers 1A to 1E to transmit the tag information, and the routine goes to Step S255.

At Step S255, the control part 157 transmits the tag information including the tag ID of the RFID tag T to the readers 1A to 1E through the tag antenna 151, and the routine goes to Step S257.

At Step S257, the control part 157 determines whether the “QueryRep” command transmitted from the readers 1A to 1E has been received through the tag antenna 151 or not. As described above, the “QueryRep” command also includes the session number X. Therefore, when the “QueryRep” command is received, the control part 157 determines whether the session number X included therein matches the session number X included in the “Query” command received at Step S215 or not at the same time. In other words, the control part 157 determines whether it is the “QueryRep” command in the same communication session or not.

If the “QueryRep” command has not been received or if the session number X included in the received command does not match the session number X included in the “Query” command immediately before, the determination at Step S257 is not satisfied. In this case, the routine returns to Step S205 and repeats the similar procedure. If the “QueryRep” command has been received and the session number X included therein matches the session number X stored by the RFID tag T, the determination at Step S257 is satisfied, and the routine goes to Step S260.

At Step S260, the control part 157 changes, that is, reverses the contents of the session flag S(X) to contents different from those before. In this example, as described above, the contents of the session flag S(X) are set only to two types, that is, “A” and “B”. Also, whichever “Select” command is received at Step S205, the contents of the session flag S(X) is set to “A” at Step S210 and the contents are maintained till the tag information is transmitted at Step S225. As a result, at Step S260, an operation to reverse the contents of the session flag S(X) from “A” to “B” at the same time is performed. Then, the routine returns to Step S205 and repeats the similar procedure.

Also, on the other hand, in the determination at Step S250, if the “Ack” command has not been received through the tag antenna 151 or even if it is received, if the contents included therein are different from the “RN16” response transmitted previously, the determination is not satisfied. That is, the control part 157 considers that the radio communication has failed for some external factor or the readers 1A to 1E allow another RFID tag circuit element To to transmit the tag information in the same identification slot. Therefore, the control part 157 transmits no signal, and the routine returns to Step S205.

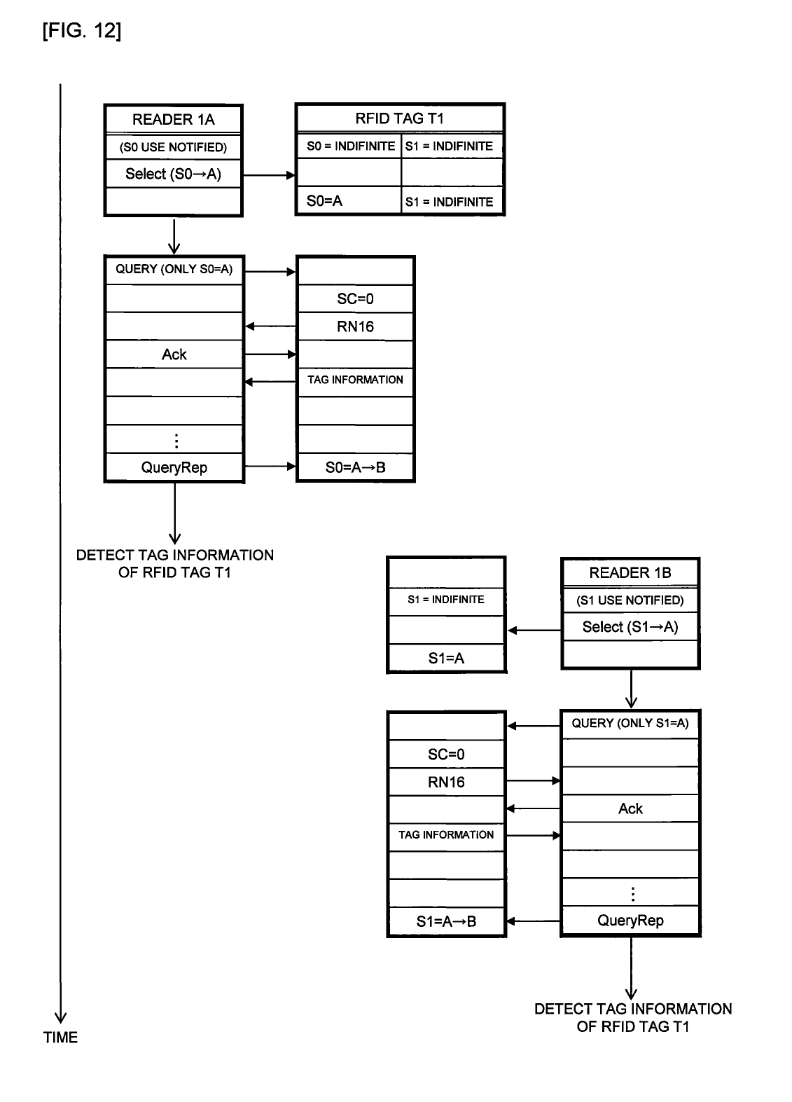

An example of signal transmission and reception between the readers 1A and 1B and the RFID tag T will be described using FIG. 12. In FIG. 12, changes in a time series from an upper side to a lower side are shown. And only the procedure of the readers 1A and 1B and the RFID tag T relating to this time series is illustrated.

In FIG. 12, in this example, cases in which each of the readers 1A and 1B detects the tag information from an RFID tag T1 present within the communicable area 20, respectively, are shown. In the reading of the RFID tag information, in this example, the reader 1A notifies the session flag S0 to the other readers 1B, 1C, 1D, and 1E for use. The session flag S0 in the figure expresses the same meaning as S(0) in the case of the session number X=0, described above. Also, in this example, the reader 1B notifies the session flag S1 to the other readers 1A, 1C, 1D, and 1E for use. The session flag S1 in the figure expresses the same meaning as S(1) in the case of the session number X=1 described above. As for the use of the other session flags S2 and S3, the explanation will be omitted.

First, in the first state, the RFID tag T1 is in an indefinite state in which the respective contents of the session flags S0 and S1 can be taken as either of “A” and “B” in this example. And the reader 1A transmits the “Select” command to instruct to set the contents of the session flag S0 to “A” without specifying any condition to perform the radio communication, that is, to all the RFID tags T present within the communicable area 20 (See Step S60 in FIGS. 8 and 10). This “Select” command is received by the RFID tag T1, and the session flag S0 is fixed to the contents of “A”.

Then, the reader 1A executes the tag information detection processing to detect the tag information of the RFID tag T1. In this tag information detection processing, the reader 1A, first, transmits the “Query” command to request a response only from the RFID tag T with the contents of the session flag S0 as “A” to all the RFID tags T present within the communicable area 20 (See Step S110 in FIG. 9). As a result, in any of the identification slots repeated after that, the tag information of the RFID tag T1 is detected. In the illustrated example, the RFID tag T1 that generates the slot count value SC of 0 by a random number from 0 to 2^{Q1}−1 immediately after the reception of the “Query” command responds to the reader 1A in the first identification slot immediately after the “Query” command.

In this first identification slot, first, the RFID tag T1 transmits the “RN16” response as a response signal to the reader 1A (See Step S245 in FIG. 11). Then, the reader 1A having received that replies the “Ack” command in response to this “RN16” response (See Step S125 in FIG. 9). Then, the RFID tag T1 receives this “Ack” command and confirms that the contents include the “RN16” response transmitted by itself as it is and then, transmits the tag information including the tag ID to the reader 1A (See Step S255 in FIG. 11). After that, in the subsequent identification slot, the RFID tag T1 receives the “QueryRep” command that specifies S0 and then, reverses the contents of the session flag S0 from “A” to “B” (Step S260 in FIG. 11). As a result, no response is made to the “Query” command that specifies S0=A, which will be received after that or the “QueryRep” command that specifies S0, but the standby state is continuously maintained.

On the other hand, in the illustrated example, the RFID tag T1 also receives the “Select” command from the reader 1B to instruct to set the contents of the session flag S1 to “A” immediately after the reception of the “Query” command from the reader 1A (See Step S60 in FIGS. 8 and 10). As a result, the session flag S1 of the RFID tag T1 is fixed to the contents as “A”. After that, similarly to the reader 1A, the RFID tag T1 receives the “Query” command to request a response only from the RFID tag T with the contents of the session flag S1 as “A” by the tag information detection processing of the reader 1B (See Step S110 in FIG. 9). Then, similarly to the above, the RFID tag T1 generates the slot count value SC by the random number from 0 to 2^{Q1}−1 immediately after the reception of the “Query” command. In this example, the RFID tag T1 generates the slot count value 0 and transmits the “RN16” response as a response signal in the first identification slot to the reader 1B (See Step S245 in FIG. 11). The reader 1B having received this “RN16” response replies the “Ack” command in response to this “RN16” response (See Step S125 in FIG. 9). Then, the RFID tag T1 receives this “Ack” command and transmits the tag information including the tag ID to the reader 1B (See Step S255 in FIG. 11). After that, the RFID tag T1 receives the “QueryRep” command that specifies S1 in the subsequent identification slot and then, reverses the contents of the session flag S1 from “A” to “B” (See Step S260 in FIG. 11). As a result, the RFID tag T1 does not respond at all to the “Query” command that is received after that and specifies S1=A and the “QueryRep” command that specifies S1 but maintains the standby state.

As described above, the two readers 1A and 1B can detect the tag information of the RFID tag T1. And this smooth tag information reading from the plurality of RFID tags is performed more smoothly by using one session flag capable of automatic reversal. In this embodiment, since the five readers 1A to 1E allocate and use the four session flags, the tag information can be obtained from the same RFID tag T at the same time in parallel without interference as described above.

In the above, Step S40 in the respective flows in FIGS. 8 and 10 constitutes a setting portion described in each claim. Also, Step S23 and Step S45 constitute a notification signal generation portion and a notification signal output portion, and Step S20 constitutes a setting element update portion. Also, Step S15 constitutes a notification signal input portion, and Step S43 constitutes a first control portion, a procedure of Step S35 constitutes a second control portion, and Step S22 constitutes a third control portion. Also, Step S110 in the flow of FIG. 9 constitutes a reading command transmission portion.

As described above, in this embodiment, how each of the four session flags S0, S1, S2, and S3 is used in all the readers 1A to 1E is stored in the form of a table (See FIG. 7) in the memory 8 of each reader 1. Then, by receiving the session notification signal from each reader 1, the time information relating to the session flag, that is, the latest notification time is updated in all the other readers 1. Therefore, each of the readers 1A to 1E can select and set such session flag that does not or hardly cause communication interference in terms of probability or the session flag with the earliest latest notification time in this example while referring to the latest stored contents of the memory when the session flag to be used by itself is set (See Step S40). As a result, using the session flag S(X) of the set session number X, the “Query” command is transmitted to the RFID tag T by the procedure at Step S110 in the flow of FIG. 9 so that the communication interference with the other readers 1 can be prevented or suppressed. Therefore, even if the plurality of readers 1 perform the reading from the same RFID tag T at the same time in parallel as exemplified in FIG. 12, each reader 1 can read information correctly and smoothly.

In the above, each reader 1 can know the session number Y of the session flag used by the other readers 1 through the session notification signal inputted at Step S15. Also, each reader 1 updates the latest notification time of the latest notification time table by session stored in the memory 8 at Step S20 in accordance with the session notification signal. At this time, in the table shown in FIG. 7, the latest notification times are arranged in the arrangement order of the session numbers, but not limited to that. That is, the latest notification times may be rearranged or sorted out in accordance with another predetermined rule or in the order of the time of the session notification signal, for example, at each update. In this case, setting of the session flag used by itself in order to avoid the communication interference can be performed more smoothly.

Also, particularly in this embodiment, the session notification signal transmitted from the single reader 1 is transmitted at the same time to all the other readers 1 by broadcast communication. As a result, the session number of the session flag used by itself can be notified to the other readers 1 without fail. Also, since there is no need to individually set the sequential communication paths to all the readers 1, the notification can be made in a short time. Moreover, there is an advantage that consumption of the internal memory 8 on the transmission side can be reduced.

Also, particularly in this embodiment, the handheld readers 1A to 1D simultaneously transmit the session notification signal to all the other readers 1A to 1E by broadcast communication when the instruction operation is made by the operator through the operation part 9 at Step S26. Similarly, the installed-type reader 1E simultaneously transmits the session notification signal to all the other readers 1A to 1E by broadcast communication when the instruction signal is inputted from the PC at Step S26A. As a result, each of the readers 1A to 1E can reliably notify the session number of the session flag used by itself to all the other readers 1A to 1E when the information reading from the RFID tag T is to be performed.

Also, the handheld readers 1A to 1D might repeat the instruction operation (See Step S26) to instruct a search and the instruction operation (See Step S10) to stop the search while being held by hand and swung around by the operator in a relatively short cycle. In such a case, if the session notification signal is transmitted each time the instruction operation to instruct the search is made, the session flags are set and updated extremely frequently in the other readers 1 having received the signal, which results in a harmful effect.

Then, particularly in this embodiment, in the handheld readers 1A to 1D, if the elapsed time since the previous session notification signal was transmitted is not more than a predetermined threshold value, that is, if it is not more than 90 seconds in the above-described example, the simultaneous transmission of the session notification signal by broadcast communication is not made even though the session number is set at Step S40 (See Step S43). That is, if an input of a tag detection operation is made once and the session notification signal is outputted to the other readers 1 once and then, the subsequent tag detection operation is inputted within 30 seconds, the session notification signal is not transmitted. As a result, excessively frequent setting or update of the session flag in the other readers 1 can be prevented. Also, with the elapsed time not more than 30 seconds, which is the threshold value, the session notification signal is not transmitted. As a result, the latest notification time of the session flag set previous time is still the earliest both in the memory 8 of the one reader 1 itself and the memories 8 of the other readers 1. As a result, the same session flag can be continuously set at Step S40, and excessive change of the session flag in the reader 1 can be prevented.

Also, particularly in this embodiment, the handheld readers 1A to 1D do not set the session number at Step S40 if the elapsed time from the input of the previous tag detection operation is not more than a predetermined threshold value or not more than 30 seconds in the above-described example. Also, the simultaneous transmission of the session notification signal at Step S43 by broadcast communication is not made, either. As a result, wasteful repetition of the setting operation of the session flag in the handheld readers 1A to 1D is prevented, and simplification of control and improvement of efficiency in the other communication processing can be promoted.

Also, particularly in this embodiment, in the installed-type reader 1E, if the elapsed time from the previous communication time T exceeds 60 minutes, the session notification signal including the session number X is simultaneously transmitted by a broadcast signal even if there is no input of a new instruction signal from the PC (See Step S22).

In the case of communication with the RFID tag T using the installed-type reader 1E, for example, after the instruction signal to instruct a search is inputted from the PC together with the power on, transmission of the “Query” command might be continued for a long time. In such a case, if the session notification signal is transmitted only at the input of the instruction signal from the PC as above, re-setting of the session number and update of the latest notification time table by session are not performed for an extremely long time. As a result, the longer the time elapses, the more likely the session number becomes the same as those of the other readers 1A to 1D, and a fear of communication interference is raised, which results in a harmful effect.

Thus, if an elapsed time from the input of the instruction signal from the PC once to the input of the subsequent instruction signal exceeds 60 minutes, the session notification signal is transmitted simultaneously in a state in which the session flag is not newly re-set even though there is no input of a new instruction signal from the PC. As a result, the above-described harmful effect is avoided, and occurrence of communication interference can be reliably prevented or suppressed.

In the present invention, a selection standard of the session number is not limited to the temporal relationship between corresponding latest notification times but the session number may be selected and set on the basis of the other standards.

In the above, arrows shown in FIGS. 3 and 4, for example, indicate examples of flows of the signals and do not limit flow directions of the signals.

Also, the flowcharts shown in FIGS. 8, 9, 10, and 11, for example, do not limit the present invention to the procedures shown in the flows, but addition and deletion or change of the order, for example, of the procedures may be made within a range not departing from the gist and the technical idea of the invention.

Other than those described above, methods of the embodiments and each variation may be combined as appropriate for use.

Though not specifically exemplified, the present invention should be put into practice with various changes made in a range not departing from its gist.

What is claimed is:

1. A radio frequency identification (RFID) tag communication system comprises:
at least one RFID tag provided with one or more reversible identifiers capable of reverse at response; and
a plurality of apparatuses for communicating with an RFID tag, each of the apparatuses being capable of communication with said at least one RFID tag, said apparatus including:
an antenna device configured to conduct radio communication with said RFID tag;
a storage device configured to store a setting element of each of said one or more reversible identifiers;
a setting portion configured to set the reversible identifier used in said radio communication performed by said antenna device on the basis of said setting element of each reversible identifier stored in said storage device;
a reading command transmission portion configured to transmit a reading command to obtain information stored in said RFID tag by means of using said reversible identifier set by said setting portion to said RFID tag;
a notification signal generation portion configured to generate an identifier notification indicating the reversible identifier set by said setting portion;
a notification signal output portion configured to output said identifier notification generated by said notification signal generation portion to the other apparatuses for communicating with an RFID tag;
a notification signal input portion configured to input said identifier notification from the other apparatuses for communicating with an RFID tag; and
a setting element update portion configured to update said setting element stored in said storage device in accordance with said identifier notification inputted by said notification signal input portion.

2. The RFID tag communication system according to claim 1, wherein:
in said apparatus,
said storage device stores time information of said identifier notification as said setting element for each reversible identifier;
said setting element update portion updates said time information relating to said corresponding reversible identifier each time said notification signal input portion inputs said identifier notification; and
said setting portion sets said reversible identifier corresponding to said earliest time information as a reversible identifier to be used in said radio communication of said antenna device on the basis of said time information of each reversible identifier stored in said storage device.

3. The RFID tag communication system according to claim 2, wherein:
said notification signal output portion of said apparatus simultaneously transmits said identifier notification to all the other apparatuses for communicating with an RFID tag.

4. The RFID tag communication system according to claim 3, wherein:
said notification signal output portion of said apparatus simultaneously transmits said identifier notification to all the other apparatuses at an input of an instruction signal to instruct transmission of said reading command by said reading command transmission portion.

5. The RFID tag communication system according to claim 4, wherein:
said apparatus further includes a first control portion configured to control said notification signal generation portion or said notification signal output portion so that said simultaneous transmission of said identifier notification is not made if an elapsed time from an output of said identifier notification previous time is not more than a predetermined first threshold value when the transmission of said reading command by said reading command transmission portion is started on the basis of a new input of said instruction signal.

6. The RFID tag communication system according to claim 5, wherein:
said apparatus further includes a second control portion configured to control said setting portion and said notification signal generation portion or said notification signal output portion so that said reversible identifier is not newly set and said simultaneous transmission of said identifier notification is not made if an elapsed time from an input of said instruction signal previous time is not more than a predetermined second threshold value when the transmission of said reading command by said reading command transmission portion is started on the basis of the new input of said instruction signal.

7. The RFID tag communication system according to claim 5, wherein:
said apparatus further includes a third control portion configured to control said notification signal generation portion and said notification signal output portion so that said simultaneous transmission of said identifier notification is made even if there is no new input of said instruction signal when an elapsed time from the input of the instruction signal exceeds a predetermined third threshold value while the transmission of said reading command by said reading command transmission portion is performed on the basis of the input of said instruction signal.

8. An apparatus for communicating with a radio frequency identification (RFID) tag comprising:
an antenna device configured to conduct radio communication with at least one RFID tag provided with one or more reversible identifiers capable of reverse at response;
a storage device configured to store a predetermined setting element for each of said one or more reversible identifiers;
a setting portion configured to set the reversible identifier used in said radio communication performed by said antenna device on the basis of said setting element of each reversible identifier stored in said storage device;
a reading command transmission portion configured to transmit a reading command to obtain information stored in said RFID tag by means of using said reversible identifier set by said setting portion to said RFID tag;
a notification signal generation portion configured to generate an identifier notification indicating the reversible identifier set by said setting portion;
a notification signal output portion configured to output said identifier notification generated by said notification signal generation portion to the other apparatuses for communicating with an RFID tag;
a notification signal input portion configured to input said identifier notification from the other apparatuses for communicating with an RFID tag; and
a setting element update portion configured to update said setting element stored in said storage device in accordance with said identifier notification inputted by said notification signal input portion.
